(19) United States
(12) Patent Application Publication
(10) Pub. No.: US 2016/0288614 A1
(43) Pub. Date: Oct. 6, 2016

(54) CONTROL DEVICE FOR CONTROLLING AT LEAST TWO AIR DISTRIBUTION FLAPS OF A HEATING AND/OR AIR-CONDITIONING UNIT OF A MOTOR VEHICLE

(71) Applicant: VALEO KLIMASYSTEME GMBH, Bad Rodach (DE)

(72) Inventor: Sebastian WILD, Neuhaus am Rennweg (DE)

(73) Assignee: VALEO KLIMASYSTEME GMBH, Bad Rodach (DE)

(21) Appl. No.: 15/035,573

(22) PCT Filed: Nov. 13, 2014
(86) PCT No.: PCT/EP2014/074426

§ 371 Date: May 10, 2016

(30) Foreign Application Priority Data
Nov. 15, 2013 (DE) 10 2013 112 631.6

(51) Int. Cl. B60H 1/00; F16H 25/18

(52) U.S. Cl. CPC B60H 1/00857; B60H 1/00678; B60H 1/00842; F16H 25/18

(57) ABSTRACT

A control device for the synchronous control of at least two air distribution flaps (10, 12, 14, 16) of a heating and/or air-conditioning unit (HVAC unit) of a motor vehicle has at least one first adjustment mechanism for a first air distribution flap pair (14, 16). The first adjustment mechanism comprises a first adjustment lever (30), which is rotatable about an axis of rotation and which has a first and a second arm (34, 36) extending from the axis of rotation and each having a connecting point. The first adjustment mechanism also comprises two coupling rods (44, 46), which are coupled to the arms (34, 36) at the connecting points, two flap levers (48), which are coupled to the coupling rods (44, 46), and two rotary spindles, which are coupled to the flap levers (48), of the air distribution flaps (14, 16). The control device may have further adjustment mechanisms of this type for the simultaneous control of further air distribution flap pairs (10, 12), wherein the adjustment mechanisms are in particular operated by means of a common control disc (20), such that altogether only one stepper motor (22) is required.

The invention relates to a control device for controlling at least two air distribution flaps of a heating and/or air-conditioning unit of a motor vehicle.

In a unit for controlling the heating, ventilation and/or air conditioning in a motor vehicle (known in the English terminology as HVAC unit; hereinafter referred to for short as heating and/or air-conditioning unit), it is normally the case that multiple electromotively driven air distribution flaps are provided which control air streams, in particular the air streams to air-cooling and air-heating elements or the air stream through air outflow openings of an air mixing and distribution chamber, which air outflow openings lead to different ventilation ducts in the vehicle. In the case of non-manual actuation of the air distribution flaps, a typical control device comprises—depending on the number of flaps to be controlled—one or more stepper motors and special cam and lever mechanisms, coupled to the stepper motor, for the adjustment of the air distribution flaps.

US 2010/0087133 A1 has disclosed a generic control device in which two air distribution flaps are controlled by only one cam/lever mechanism. A crank on the axis of rotation of the first flap has a pin which is guided in a groove of a motor-driven cam, such that a rotation of the cam effects an adjustment of the first flap. For the simultaneous adjustment of the second flap, a coupling rod is provided which connects the crank of the first flap to a crank of the second flap. To eliminate play in the direction of rotation, a conical pin and a groove with a V-shaped cross section are provided. If the pin is inserted into the groove to an adequate depth, contact is always ensured.

EP 0 267 101 A1 likewise presents a cam/lever mechanism for the simultaneous control of two air distribution flaps, which cam/lever mechanism operates with only one cam, one crank, acting as adjustment lever, for the direct control of the first flap, and one connecting rod, connected to a crank of the second flap, for the control of the second flap.

Said solutions known from the prior art can however be realized in practice only if the distance between the two flaps to be controlled is not too great and no other obstructive components of the heating and/or air-conditioning unit are arranged in between.

It is an object of the invention to realize a reliable control device, which is of simple construction, for the control of air distribution flaps, by means of which control device at least two air distribution flaps can be adjusted uniformly.

Said object is achieved by means of a control device having the features of claim 1. Advantageous and expedient refinements of the control device according to the invention are specified in the subclaims.

The control device according to the invention serves for the synchronous control of at least two air distribution flaps of a heating and/or air-conditioning unit of a motor vehicle and has at least one first adjustment mechanism for a first air distribution flap pair. The first adjustment mechanism comprises a first adjustment lever, which is rotatable about an axis of rotation and which has a first and a second arm extending from the axis of rotation and each having a connecting point. The first adjustment mechanism also comprises two coupling rods, which are coupled to the arms at the connecting points, two flap levers, which are coupled to the coupling rods, and two rotary spindles, which are coupled to the flap levers, of the air distribution flaps.

The invention permits simultaneous and synchronous adjustment of at least two air distribution flaps. Here, a synchronous adjustment should be understood primarily to mean that the two air distribution flaps are placed into a (fully) open or closed position simultaneously. The concept on which the invention is based, that of the “equal” control of the air distribution flaps, ensures that the force distribution on the two flaps is uniform. A particular advantage of the construction according to the invention is that it operates with only one adjustment lever per air distributor flap pair. A further advantage of the control device proposed here is the possibility of further adjustment mechanisms of identical construction being coupled thereto such that, despite this, only a single stepper motor is required. The saving of components (no second adjustment lever and no second stepper motor) results firstly in a cost saving; secondly, valuable structural space is also saved.

In a preferred embodiment, in the case of the first adjustment lever, the connecting points of the first and second arms are, with regard to the simultaneous synchronous adjustment of the two air distribution flaps, at the same radial distance from the axis of rotation of the first adjustment lever, and a virtual connecting line between the connecting points intersects the axis of rotation of the adjustment lever. This means that the connecting points and axis of rotation of the first adjustment lever lie in a plane. The symmetrical arrangement of the connecting points of the first adjustment lever with respect to the axis of rotation is the basis for a uniform deflection of the coupling rods coupled thereto. With suitable arrangement of the further components of the adjustment mechanism, it is then easily possible to realize a uniform deflection of the air distribution flaps.

The control concept according to the invention can be implemented most simply by virtue of the first adjustment lever being directly coupled to a drive shaft of a stepper motor. In this way, it is possible to control at least two air distribution flaps without further coupling elements, such as a control disc etc., being required for this purpose. Such a construction accordingly has a particularly space-saving effect.

If, in accordance with the invention, it is the intention for multiple air distribution flap pairs to be adjusted simultaneously using one stepper motor, a construction is required in which one motor-driven element can simultaneously control multiple adjustment mechanisms, such as for example one control disc with multiple control grooves. With regard to the first adjustment mechanism, it is provided in this case that the first adjustment lever has - aside from the two arms to which the coupling rods are coupled - a third arm with a pin which engages into a first control groove of a rotatable control disc. The control groove and the pin guided therein form a type of slotted control guide for the deflection of the first adjustment lever. In the same way, multiple adjustment mechanisms can be controlled by means of the control disc if the latter has multiple control grooves.

With regard to a reliable and reproducible deflection of the first adjustment lever, it is recommendable for the first adjustment lever to be mounted on a housing (which is immovable relative to the control disc) of the control device, with the pin extending parallel to the axis of rotation of the adjustment lever.

For the synchronicity of the control device and the uniform force distribution on the air distribution flaps, a construction is advantageous in which the air distribution flaps are arranged mirror-symmetrically with respect to a plane of symmetry, as will be explained in more detail below.

In particular, the axis of rotation of the control disc should run in said plane of symmetry, such that the rotation of the control disc has an equal action on both air distribution flaps.

Furthermore, the coupling rods should be of equal length, and preferably, the flap levers should be of equal length and positioned mirror-symmetrically with respect to one another about the plane of symmetry. It is thus possible to ensure a fully synchronous adjustment even with regard to all intermediate positions between an open and a closed position of the air distribution flaps.

It is preferred for the coupling rods to be connected to the first and second arms of the first adjustment lever and/or to the flap levers by coupling by way of ball joints. By comparison to simple rotary joints, ball joints permit, for example, more flexibility with regard to the spatial arrangement of the components involved.

As already mentioned, the invention is particularly highly suitable for the simultaneous control of at least one further air distribution flap pair. For such an application, at least one second adjustment mechanism for a second air distribution flap pair is provided. Analogously to the first adjustment mechanism, the second adjustment mechanism comprises a second adjustment lever, which is rotatable about an axis of rotation and which has a first and a second arm extending from the axis of rotation and each having a connecting point, two coupling rods, which are coupled to the arms at the connecting points, two flap levers, which are coupled to the coupling rods, and two rotary spindles, which are coupled to the flap levers, of the air distribution flaps. With such an expanded construction, it is possible in particular to control a left-side and a right-side air distribution flap for the back seat area and, simultaneously, a left-side and a right-side air distribution flap for the back seat footwell.

A second adjustment mechanism of said type can advantageously be controlled by means of the same control disc as the first adjustment mechanism. For this purpose, the second adjustment lever has a third arm with a pin which engages into a second control groove of the rotatable control disc. The second control groove may either have substantially the same profile as the first control groove in order to achieve synchronicity with the first adjustment mechanism, or the second control groove has a different profile if a different adjustment profile is desired.

The control grooves of the first and second adjustment mechanisms may be formed on opposite sides of the control disc. A control disc with a relatively small diameter is adequate for this purpose.

It is likewise possible, in the case of a control disc with suitably large diameter, for both (or even more) control grooves to be provided on the same side. In this case, it is self-evidently additionally possible for one or more control grooves to be provided on the other side of the control disc.

In any case, the control disc permits the simultaneous control of a multiplicity of air distribution flaps using only one stepper motor.

In order, in the case of the second adjustment mechanism also, to realize a synchronous adjustment of the two associated air distribution flaps with respect to one another and a uniform force distribution, said air distribution flaps should likewise be arranged mirror-symmetrically with respect to a plane of symmetry, wherein the axis of rotation of the control disc runs in the plane of symmetry and, preferably, the coupling rods of the second adjustment mechanism are of equal length, and/or the flap levers of the second adjustment mechanism are of equal length and are positioned mirror-symmetrically with respect to one another about the plane of symmetry, and/or the connecting points of the first and second arms of the second adjustment lever are at the same radial distance from the axis of rotation of the second adjustment lever, and a virtual connecting line between these connecting points intersects the axis of rotation of the second adjustment lever.

Further features and advantages of the invention will emerge from the following description and from the appended drawings, to which reference is made. In the drawings:

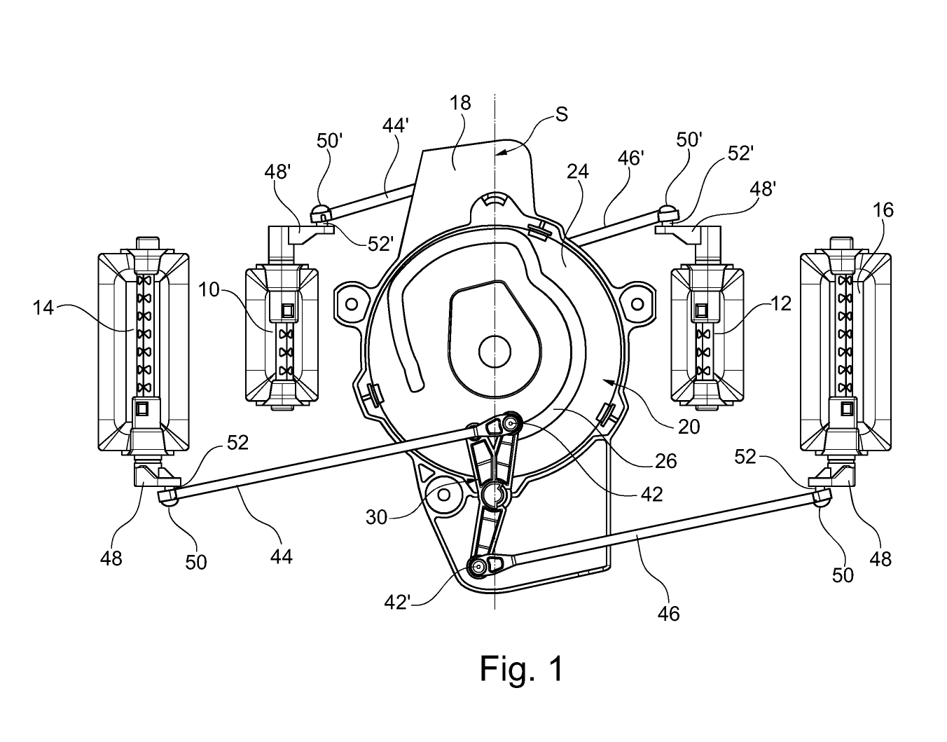

FIG. 1 shows a view from below of a control device according to the invention;

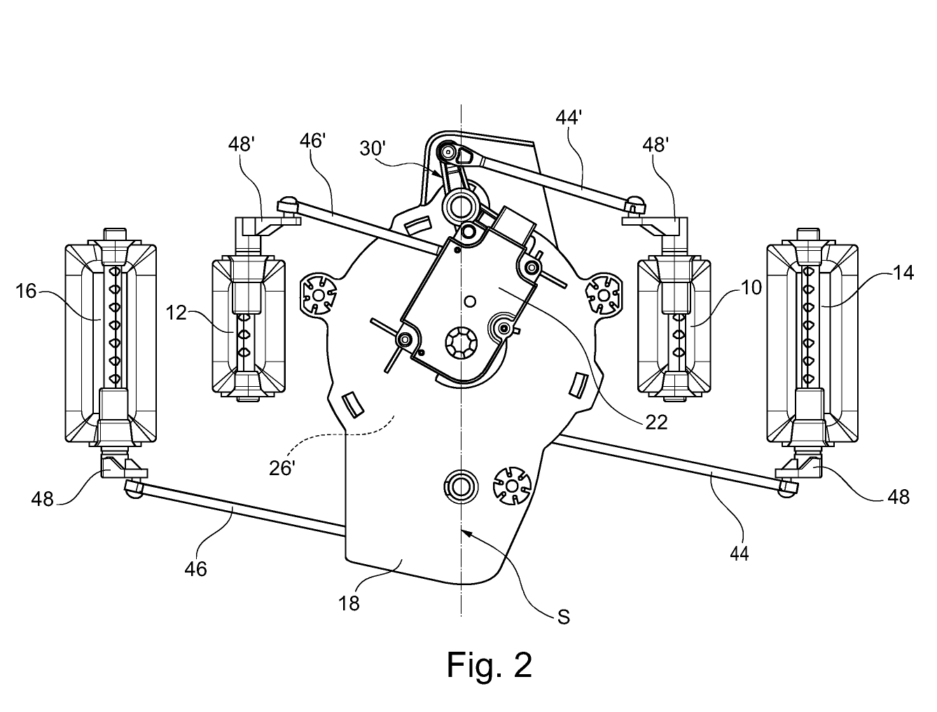

FIG. 2 shows a plan view of the control device according to the invention from FIG. 1;

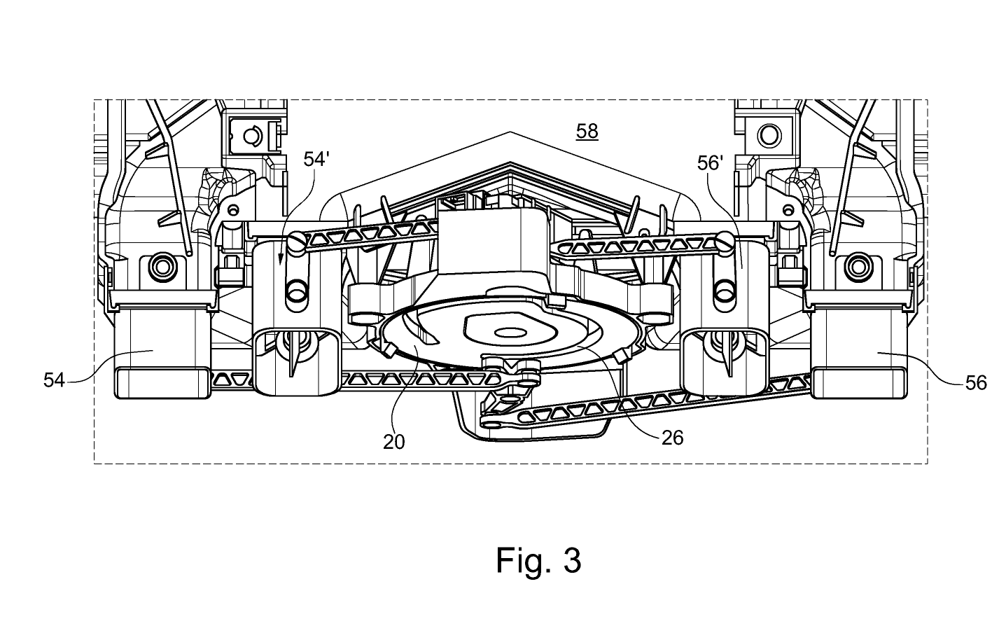

FIG. 3 shows a front view of the control device according to the invention from FIG. 1 in the installed state in an air distribution unit;

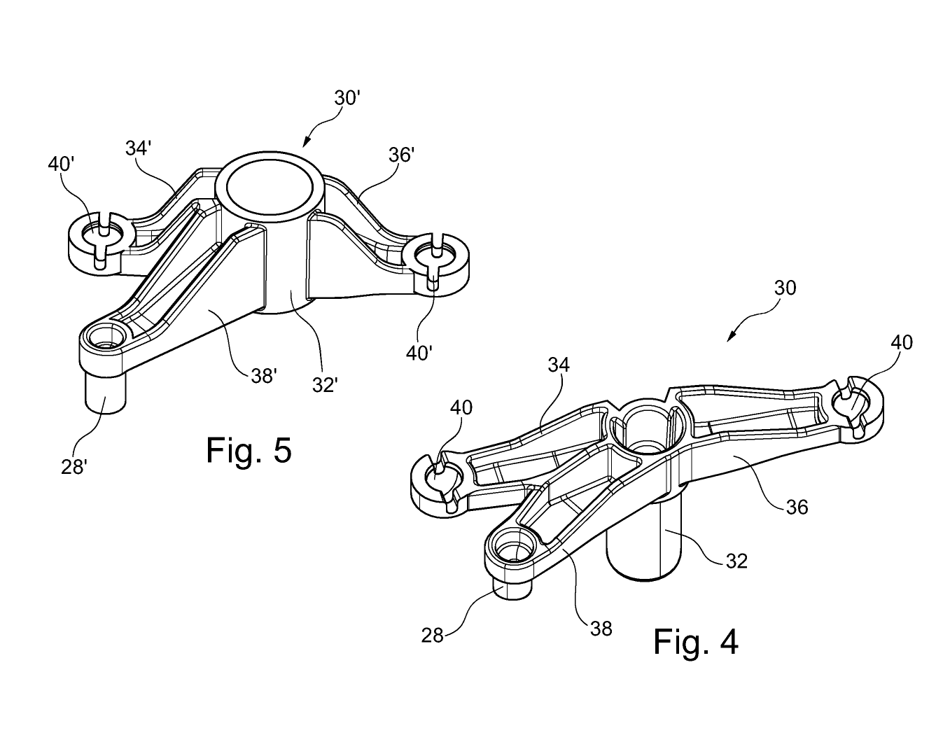

FIG. 4 shows a perspective view of a first adjustment lever of the control device according to the invention; and

FIG. 5 shows a perspective view of a second adjustment lever of the control device according to the invention.

FIGS. 1 to 3 illustrate a control device for the control of multiple air distribution flaps of a heating and/or air-conditioning unit (HVAC unit) of a motor vehicle. More precisely, the control device that will be described in detail below serves for the simultaneous adjustment of a left-side and a right-side air distribution flap 10, 12 for the back seat area and of a left-side and a right-side air distribution flap 14, 16 specifically for the back seat footwell of a motor vehicle.

The control device comprises a control disc 20 which is accommodated in a housing 18 and which can be rotated about its central axis by a stepper motor 22. The control disc 20 has a first control groove 26 on its underside 24. A pin 28 of a first adjustment lever 30 engages into the first control groove 26. The first adjustment lever 30 is part of a first adjustment mechanism, the construction of which will be described below.

The first adjustment lever 30, which is illustrated on its own in FIG. 4, has a central rotary bearing 32, by means of which the adjustment lever 30 is mounted rotatably on the housing 18, and three rigid arms 34, 36, 38, which extend from the rotary bearing 32.

Integrally formed on the free end of the third arm 38 is the pin 28 which extends parallel to the axis of rotation of the adjustment lever 30. The first and second arms 34, 36, which at their free ends each have a connecting point in the form of a joint socket 40, are symmetrical with respect to a plane running through the axis of rotation. In particular, the central points of the two joint sockets 40 are at the same radial distance from the axis of rotation, and a virtual connecting line between the central points of the two joint sockets 40 intersects the axis of rotation.

The two joint sockets 40 are parts of two ball joints, the associated joint head 42 of which are formed on two coupling rods 44, 46. As can be seen in FIG. 1, the first coupling rod 44 extends from the first arm 34 of the adjustment lever 30 to a flap lever 48 of the left-side air distribution flap 14, whereas the second coupling rod 46 extends from the second arm 36 of the adjustment lever 30 to a flap lever 48 of the right-side air distribution flap 16. Each coupling rod 44, 46 has, on its other end, a connecting point in the form of a joint socket 50, which forms a ball joint together with a joint head 52 on a free end of the associated flap lever 44, 46. The other end of each flap lever 48 is coupled rotationally conjointly to a rotary spindle of the associated air distribution flap 14, 16. The flap levers 48 each form, with the coupling rods 44, 46, a crank by which the associated air distribution flap 14, 16 can be rotated about its rotary spindle and thus adjusted.

As can be seen in FIG. 3, the air distribution flaps 14, 16 are each arranged in an air flow duct 54, 56. The air flow ducts 54, 56 belong to a distributor housing 58 of an air distribution unit of the heating and/or air-conditioning unit of the motor vehicle.

The configuration and arrangement of the components of the first adjustment mechanism are determined by a plane of mirror symmetry S between the air distribution flaps 14 and 16 (first air distribution flap pair), wherein said plane corresponds to the central plane of the distributor housing 58. In an initial position, the axis of rotation of the control disc 20 runs in the plane S, the first and second arms 34, 36 of the first adjustment lever 30 are positioned mirror-symmetrically, and the coupling rods 44, 46 are of exactly the same length, and also, the flap levers 48 are of exactly the same length and are positioned mirror-symmetrically with respect to one another.

As can be seen from FIGS. 2 and 3, the control device has a second adjustment mechanism for the air distribution flaps 10, 12 for the back seat area. For this purpose, on the top side (hidden by the housing 18 in FIGS. 2 and 3) of the control disc 20, there is formed a second control groove 26′ (likewise hidden in FIGS. 2 and 3) into which a pin 28′ of a second adjustment lever 30′ engages. The second adjustment mechanism with the second adjustment lever 30′ is of basically the same construction as the first adjustment mechanism described above, such that in this regard, reference can be made to the description above. Identical components are denoted in the figures by the same reference signs, supplemented by an ′ in the case of the second adjustment mechanism.

Even though the dimensions and the relative arrangement of the components of the second adjustment mechanism are adapted to the position and geometry of the air distribution flaps 10, 12 for the back seat area (second air distribution flap pair), and therefore differ at least in part from the corresponding dimensions and corresponding relative arrangement of the components of the first adjustment mechanism, the same symmetry principle nevertheless applies. This means that the plane of mirror symmetry S also relates to the second air distribution flap pair 10, 12, and the configuration and arrangement of the components of the second adjustment mechanism is likewise determined by the plane of mirror symmetry S.

The mode of operation of the two adjustment mechanisms that are coupled to one another by the common control disc 20 is likewise the same. By means of a rotation of the control disc 20 that is driven by the stepper motor 22, the adjustment lever 30, 30′ is in each case pivoted about the axis of rotation of the adjustment lever 30, 30′ by the control groove 26, 26′, which serves as a slotted guide for the pin 28, 28′. As a result, the two joint sockets 40, 40′ of the first and second arms 34, 34′, 36, 36′ of the respective adjustment mechanism move along a common virtual circular path. The resulting deflection of the coupling rods 44, 44′, 46, 46′ leads to a rotation of the rotary spindles of the air distribution flaps 10, 12, 14, 16 until a desired position of the air distribution flaps 10, 12, 14, 16 is attained.

With the control device, it is thus possible, using only one stepper motor 22, for both the left-side and the right-side air distribution flaps 10, 12 for the back seat area and the left-side and the right-side air distribution flaps 14, 16 for the back seat footwell to be adjusted in absolutely synchronous fashion, wherein the profile of the control grooves 26, 26′ on the control disc 20 is decisive in determining the kinematics and thus the profile of the adjustment for the associated air distribution flap pairs 10, 12 and 14, 16 in a manner dependent on the rotational angle of the control disc 20.

Various modifications of the control device are possible in departure from the exemplary embodiment illustrated in the figures. For example, it is possible for more than one control groove to be provided on one side of the control disc 20, and correspondingly for multiple synchronous adjustment mechanisms to be provided, if it is sought to control an even greater number of air distribution flap pairs simultaneously by means of a rotation of the control disc 20. It is self-evidently also possible for the control disc 20 to have no control groove whatsoever on one side, such that only the other side is utilized for coupling purposes. Furthermore, instead of the ball joints between the coupling rods 44, 44′, 46, 46′ and the arms 34, 34′, 36, 36′, 38, 38′ of the adjustment levers 30, 30′ and/or the flap levers 48, 48′, other articulated connections may be selected, for example joints with pins that engage into elongate holes; in this case, the axis of rotation of the adjustment lever 30, 30′ and the connecting points of said adjustment lever to the coupling rods 44, 44′, 46, 46′ need not imperatively lie in the same plane.

If only one air distribution flap pair has to be controlled using the stepper motor 22, only one adjustment lever 30 or 30′ is required, which can then be coupled directly to the drive shaft of the stepper motor 22. In this case, the control disc 20 with the control groove 26 or 26′ and the third arm 38 or 38′ of the adjustment lever 30 or 30′ can be dispensed with.

It is then also possible for the housing 18 to be of simplified design or omitted entirely.

### LIST OF REFERENCE SIGNS

10 Left-side air distribution flap
12 Right-side air distribution flap
14 Left-side air distribution flap (back seat footwell)
16 Right-side air distribution flap (back seat footwell)
18 Housing
20 Control disc
22 Stepper motor
24 Underside
26, 26′ First/second control groove
28, 28′ Pin
30, 30′ First/second adjustment lever
32, 32′ Rotary bearing
34, 34′ First arm
36, 36′ Second arm
38, 38′ Third arm
40, 40′ Joint socket
42, 42′ Joint head
44, 44′ First coupling rod
46, 46′ Second coupling rod
48, 48′ Flap lever
50, 50′ Joint socket
52, 52′ Joint head
54, 54′ First air flow duct
56, 56′ Second air flow duct
58 Distributor housing

1. A control device for controlling at least two air distribution flaps of a heating and/or air-conditioning unit of a motor vehicle, comprising:
a first adjustment mechanism for a first air distribution flap pair, wherein the first adjustment mechanism comprises a first adjustment lever, which is rotatable about an axis of rotation and which has a first and a second arm extending from the axis of rotation and each having:
a connecting point, two coupling rods coupled to the arms at the connecting points, two flap levers coupled to the coupling rods, and two rotary spindles coupled to the flap levers of the air distribution flap pair.

2. The control device according to claim 1, wherein the connecting points of the first and second arms are at the same radial distance from the axis of rotation of the first and a virtual connecting line points intersects the axis of adjustment lever.

3. The control device according to claim 1, wherein the first adjustment lever is directly coupled to a drive shaft of a stepper motor.

4. The control device according to claim 1, wherein the first adjustment lever has a third arm with a pin which engages into a first control groove of a rotatable control disc.

5. The control device according to claim 4, wherein the first adjustment lever is mounted on a housing of the control device, wherein the pin extends parallel to the axis of rotation of the adjustment lever.

6. The control device according to claim 4, wherein the air distribution flaps are arranged mirror-symmetrically with respect to a plane of symmetry.

7. The control device according to claim 6, wherein the axis of rotation of the control disc runs in the plane of symmetry.

8. The control device according to claim 6, wherein the coupling rods are of equal length.

9. The control device according to claim 6, wherein the flap levers are of equal length and are positioned mirror-symmetrically with respect to one another about the plane of symmetry.

10. The control device according to claim 1, wherein the coupling rods are coupled by means of ball joints to the first and second arms of the first adjustment lever and/or to the flap lever.

11. The control device according to claim 4, further comprising:
a second adjustment mechanism for a second air distribution flap pair, wherein the second adjustment mechanism comprises a second adjustment lever, which is rotatable about an axis of rotation and which has a first and a second arm extending from the axis of rotation and each having:
a connecting point, two coupling rods coupled to the arms at the connecting points, two flap levers coupled to the coupling rods, and two rotary spindles, which are coupled to the flap levers of the air distribution flap pair.

12. The control device according to claim 11 wherein the second adjustment lever has a third arm with a pin which engages into a second control groove of the rotatable control disc.

13. The control device according to claim 12, wherein the first and second control grooves are formed on opposite sides of the control disc.

14. The control device according to claim 12, wherein the first and second control grooves are formed on the same side of the control disc.

15. The control device according to claim 11, wherein:
the air distribution flaps of the second air distribution flap pair are arranged mirror-symmetrically with respect to a plane of symmetry, wherein the axis of rotation of the control disc runs in the plane of symmetry and,
the coupling rods of the second adjustment mechanism are of equal length, and/or
the flap levers of the second adjustment mechanism are of equal length and are positioned mirror-symmetrically with respect to one another about the plane of symmetry, and/or
the connecting points of the first and second arms of the second adjustment lever are at the same radial distance from the axis of rotation of the second adjustment lever, and a virtual connecting line between these connecting points intersects the axis of rotation of the second adjustment lever.
